(19) United States
(12) Patent Application Publication
(10) Pub. No.: US 2007/0045986 A1
(43) Pub. Date: Mar. 1, 2007

(54) Hitch accessory receiving mount

(76) Inventor: Brad Thomas Lirot, Sandwich, IL (US)

Correspondence Address: GERRY FISCHER, 954 ARNOLD COURT, DES PLAINES, IL, 60016, US

(21) Appl. No.: 11/212,197

(22) Filed: Aug. 26, 2005

(51) Int. Cl. B60D 1/14

(52) U.S. Cl. 280/495

(57) ABSTRACT

A hitch accessory receiving mount is provided including a receiver tube including a set of aligned pin holes and a mount support frame attached to the receiver tube. In one embodiment, the mount support frame has a plurality of mounting holes and at least one access hole aligned with at least one of the mounting holes. In another embodiment, a mounting hole is located in the center of the mount support frame through the receiver tube.

### BACKGROUND OF INVENTION

### Field of the Invention

The present invention relates to a new receiving mount device to securely mount hitch accessories, attachments and other equipment. The receiving mount device may be securely mounted to any receptive location and may be portably moved and attached to any available stable or mobile receptacle.

Many vehicles are equipped with receiver tube trailer hitches. These trailer hitches are typically 1.25 or 2 square inches in internal height and width and attached to the undercarriage of a vehicle. A second tube is generally inserted into the aforementioned receiver tube as the support member of a hitch accessory. The hitch accessory may be a trailer ball or hitch, carrying basket, table, work surface, tire rack, hitch steps, an extension tube, bike rack, deck frame or any other hitch accessory.

To make use of hitch accessories, these accessories have previously been coupled to a receiver tube hitch attached to a vehicle. Hitch accessories, when detached from the vehicle's receiver tube hitch, are impractical to use, store, and secure.

Therefore there is a need for a device that provides a means for using, storing and securing hitch accessories when the hitch accessories are not attached to the receiver tube hitch of a vehicle.

### SUMMARY OF INVENTION

A hitch accessory receiving mount comprising a receiver tube including a set of aligned pin holes and a mount support frame attached to the receiver tube is disclosed.

The foregoing and other features and advantages of the invention are apparent from the following detailed description of the exemplary embodiments, read in conjunction with the accompanying drawings. The detailed description and drawings are merely illustrative of the invention rather than limiting, the scope of the invention being defined by the appended claims and equivalents thereof.

### DESCRIPTION OF THE DRAWINGS

FIG. 1 illustrates a hitch accessory receiving mount in accordance with an embodiment of the invention;

FIG. 2 illustrates a cross-sectional view of the back of the hitch accessory receiving mount in accordance with a preferred embodiment of the invention;

FIG. 3 illustrates a cross-sectional view of the front of the hitch accessory receiving mount in accordance with a preferred embodiment of the invention;

FIG. 4 illustrates a cross-sectional view of the left side of the hitch accessory receiving mount in accordance with a preferred embodiment of the invention;

FIG. 5 illustrates a cross-sectional view of the right side of the hitch accessory receiving mount in accordance with a preferred embodiment of the invention;

FIG. 6 illustrates a cross-sectional view of the mount support frame of the hitch accessory receiving mount in accordance with a preferred embodiment of the invention; and

FIG. 7 illustrates a cross-sectional view of the receiver tube of the hitch accessory receiving mount in accordance with a preferred embodiment of the invention.

### DETAILED DESCRIPTION OF THE INVENTION

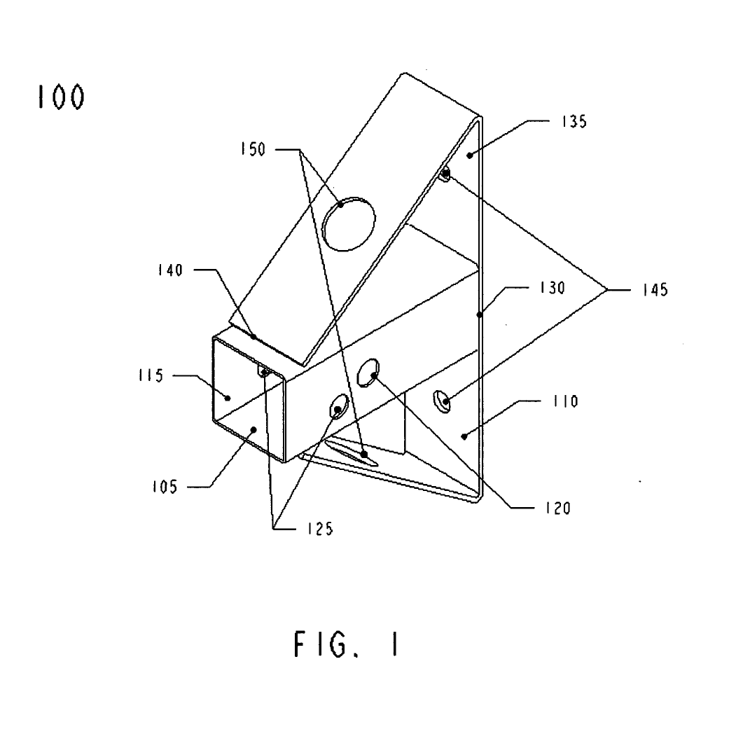

FIG. 1 illustrates one embodiment of a hitch accessory receiving mount in accordance with the invention at 100. The hitch accessory receiving mount 100 comprises a receiver tube 105 and a mount support frame 135. The receiver tube 105 has a substantially square front opening 115 for receiving 2″×2″ or 1.25″×1.25″ hitch accessories and a receiver tube back end 130 secured to a mount support frame 135. Further, in one embodiment of the invention, the receiver tube 105 has two pair of aligned pin holes 120 and 125 in the sides of the receiver tube 105 for securing said hitch accessories.

The hitch accessory receiving mount 100 allows hitch accessories to be used most anywhere other than the back of a vehicle. The hitch accessory receiving mount 100 is not intended for use as an automotive tow hitch. The hitch accessory receiving mount 100 is portable and provides a safe and secure means of storing hitch accessories of all kinds, thus allowing hitch accessories to be stored more practically and used for more applications.

In an embodiment of the invention, a first pair of aligned pin holes 125 is 0.5625″ in diameter and located 1.625″ from the substantially square front opening 115 of the receiver tube 105. The first pair of aligned pin holes 125 is used to secure 1.25″ square hitch accessories.

A second pair of aligned pin holes 120 is 0.65625″ in diameter and located 2.5″ from the substantially square front opening 115 of the receiver tube 105. The second pair of aligned pin holes 120 is used to secure 2″ square hitch accessories. The second pair of aligned pin holes 120 is centered on the sides of the receiver tube 105.

The receiver tube back end 130 is secured to the center of the mount support frame 135. FIG. 1 illustrates the mount support frame 135 additionally secured to the receiver tube 105 near the substantially square front opening 115 at the top and bottom of the receiver tube 105.

In one embodiment, the receiver tube 105 is made of heavy gauge carbon steel with an exterior grade finish. The receiver tube back end 130 is welded to the center of the mount support frame 135. Further, for additional strength and support, the mount support frame welded to top and bottom sides of the receiver tube 105 at or near the substantially square front opening 115 providing for a somewhat triangular shape of the hitch accessory receiving mount 100.

The hitch accessory receiving mount 100 may be temporarily fastened to a secured or stationary object or other receptive location including, but not limited to trees, walls, and posts. The hitch accessory receiving mount 100 may be temporarily or permanently fastened to the receptive location with a heavy duty ratcheting strap wrapped through the mount support frame 135 and around the receptive location.

FIG. 1 illustrates the mount support frame 135 comprising a plurality of mounting holes 145 and access holes 150. The hitch accessory receiving mount 100 mount support frame 135 mounting holes 145 provide a more stable means for fastening the hitch accessory receiving mount 100 to a receptive location. The hitch accessory receiving mount 100 may be anchored to a receptive location by using rope, straps or other securing means for a less permanent application or anchored into the receptive location with through bolts, lag bolts or other securing hardware.

The height at which the hitch accessory receiving mount 100 is secured to the receptive location may be varied based on need and application. For example, the hitch accessory receiving mount 100 may be secured at an elevated position when receiving a boat trailer requiring draining, cleaning or maintenance. The hitch accessory receiving mount 100 may be secured at a lower lever when receiving hitch accessories such as a cargo carrier for use as a table or work surface.

The illustrated mounting holes 145 are 0.5″ in diameter. The illustrated access holes 150 are 1.25″ in diameter. The access holes 150 provide clearance for a ratchet type wrench to pass through the mount support frame 135 to access any mounting hardware used in the mounting holes 145.

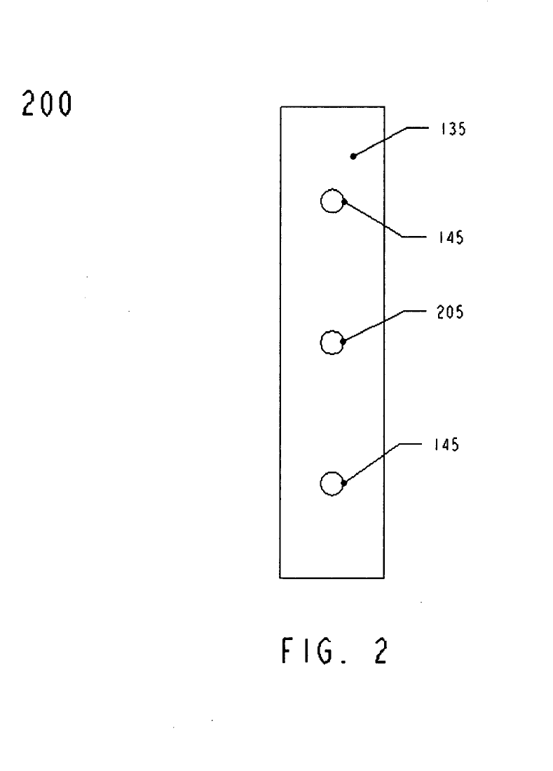

FIG. 2 illustrates a cross-sectional view of the back of the hitch accessory receiving mount 200 in accordance with one embodiment of the invention. FIG. 2 illustrates the mount support frame 135 mounting holes 145 and an additional center mounting hole 205. The illustrated center mounting hole 205 is also 0.5″ in diameter. In one embodiment, the length of the mount support frame 135 back is 10″ and the width of the mount support frame 135 is 2.25″.

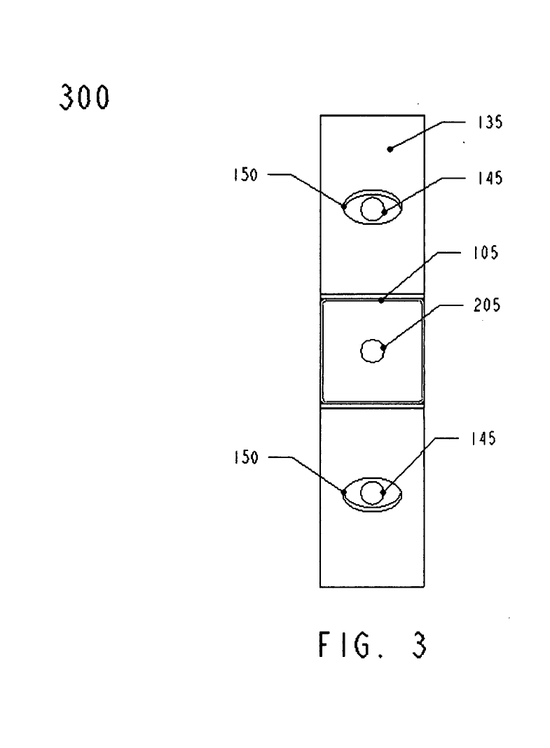

FIG. 3 illustrates a cross-sectional view of the front of the hitch accessory receiving mount 300 in accordance with one embodiment of the invention. Access to the illustrated center mounting hole 205 is provided through the receiver tube 105. The location of the center mounting hole 205 enhances theft deterrence by limiting access to mounting hardware for the center mounting hole 205 while the support member of the hitch accessory is inserted and locked in place in the hitch accessory receiving mount 300.

FIG. 3 further illustrates the alignment of the mounting holes 145 and the access holes 150 of the mount support frame 135. All three mounting holes 145 and 205 this embodiment have direct access with a ratchet type wrench either through the access holes 150 or through the center of the receiver tube 105, said receiver tube 105 being fixably attached to the center of the mount support frame 135.

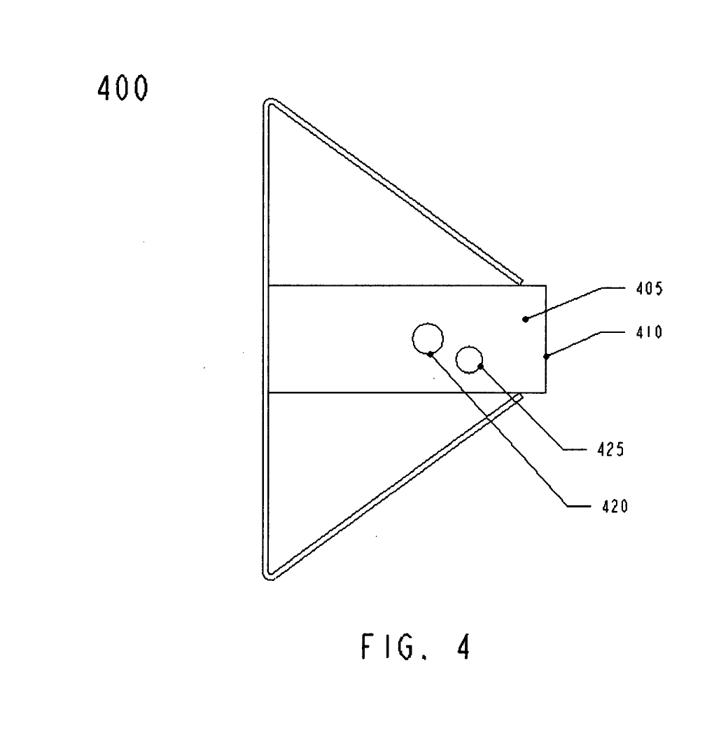

FIG. 4 illustrates a cross-sectional view of the left side of the hitch accessory receiving mount in accordance with one embodiment of the invention, having a receiver tube 405 that is 5.875″ in length and an overall length of the hitch accessory receiving mount of 6″. In FIG. 4, the left side of the receiver tube 405 illustrates an aligned pin hole 425 that is 0.5625″ in diameter and located 1.625″ from the substantially square front opening 410 of the receiver tube 405. The illustrated aligned pin hole 425 is used to secure 1.25″ hitch accessories. Another aligned pin hole 420 that is 0.65625″ in diameter and located 2.5″ from the substantially square front opening 410 of the receiver tube 405. The second aligned pin holes 420 is used to secure 2″ hitch accessories.

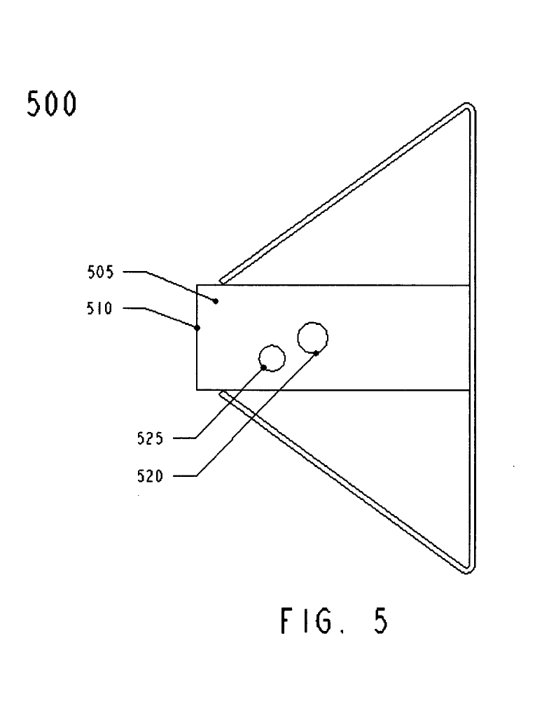

FIG. 5 illustrates a cross-sectional view of the right side of the hitch accessory receiving mount in accordance with one embodiment of the invention. In FIG. 5, the right side of the receiver tube 505 illustrates an aligned pin hole 525 that is 0.5625″ in diameter and located 1.625″ from the substantially square front opening 510 of the receiver tube 505. Another aligned pin hole 520 that is 0.65625″ in diameter and located 2.5″ from the substantially square front opening 510 of the receiver tube 505. In one embodiment, the aligned pin holes 525 and 520 are substantially parallel to the aligned pin holes 425 and 420 (of FIG. 4), respectively.

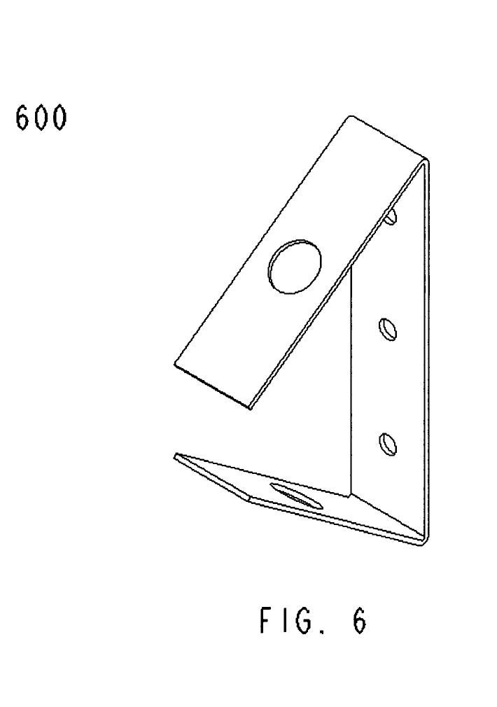

FIG. 6 illustrates a cross-sectional view of the mount support frame of the hitch accessory receiving mount in accordance with one embodiment of the invention. In FIG. 6, the mount support frame 600 illustrates a substantially triangular shape. In one embodiment, the mount support frame 600 is made of one piece of heavy gauge carbon steel with an exterior grade finish, bent in two locations to form the triangular shape illustrated. The location and angles of the two bent locations provide for strength and support of the mount support frame for a preferred method of attaching a receiver tube to manufacture a hitch accessory receiving mount.

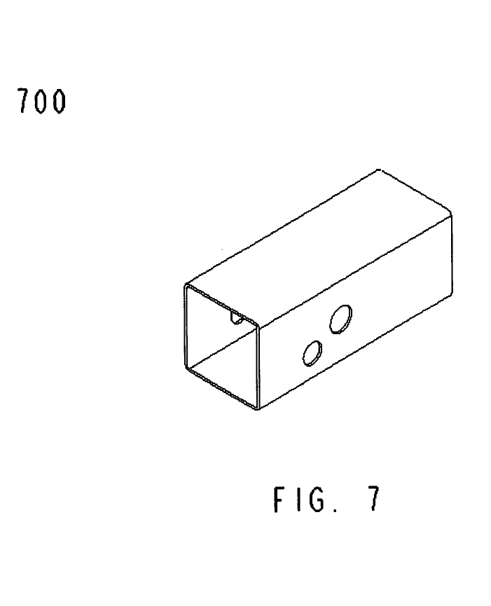

FIG. 7 illustrates a cross-sectional view of the receiver tube of the hitch accessory receiving mount in accordance with a preferred embodiment of the invention. In one embodiment, the receiver tube 700 is made of one piece of heavy gauge carbon steel with an exterior grade finish, formed into an elongated square opening tube as illustrated. The receiver tube 700 inserted and welded to mount support frame of FIG. 6 at or near open ends of the receiver tube 700 in one embodiment.

While the preferred embodiments of the invention have been shown and described, numerous variations and alternative embodiments will occur to those of ordinary skill in the art. Accordingly, it is intended that the invention not be limited as described, but also encompass the equivalents of the invention described, as well as any improvements which are obvious to those of ordinary skill in the art. Those of ordinary skill in the art will recognize that the product and method disclosed herein may be readily adapted in a variety of manners.

What is claimed is:

1. A hitch accessory receiving mount comprising:
a receiver tube including a set of aligned pin holes; and
a mount support frame attached to the receiver tube.

2. The hitch accessory receiving mount of claim 1 wherein the receiver tube includes a plurality of aligned pin holes.

3. The hitch accessory receiving mount of claim 1 wherein the mount support frame is substantially triangular.

4. The hitch accessory receiving mount of claim 1 wherein the receiver tube accepts two inch hitch accessories.

5. The hitch accessory receiving mount of claim 1 wherein the receiver tube accepts 1.25 inch hitch accessories.

6. The hitch accessory receiving mount of claim 1 wherein the mount support frame includes a plurality of mounting holes.

7. The hitch accessory receiving mount of claim 1 wherein the back of the receiver tube is attached to the center of the mount support frame.

8. The hitch accessory receiving mount of claim 7 wherein the mount support frame is attached to the front of the receiver tube.

9. The hitch accessory receiving mount of claim 6 wherein at least one mounting hole is located inside the receiver tube.

10. The hitch accessory receiving mount of claim 6 wherein the mount support frame is attached to front and back of the receiver tube.

11. The hitch accessory receiving mount of claim 6 wherein the mount support frame includes at least one access hole aligned with at least one mounting hole.

12. A method for constructing a hitch accessory receiving mount, the method comprising:
providing a receiver tube including a set of aligned holes; and
attaching a mount support frame to the receiver tube.
